(19) United States
(12) Patent Application Publication
(10) Pub. No.: US 2010/0019184 A1
(43) Pub. Date: Jan. 28, 2010

(54) VALVE SEAL WITH INTEGRAL FLEXURE JOINTS

(75) Inventor: Justin A. Tanner, Queen Creek, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/179,210

(22) Filed: Jul. 24, 2008

(51) Int. Cl. F16K 1/226

(52) U.S. Cl. 251/306; 251/314; 251/368

(57) ABSTRACT

A valve seal for use with a valve having a valve element including a plurality of radiused corners. The valve element is rotatably mounted within a frame disposed in a flowbody. The valve seal including a plurality of curved portions in cooperative alignment with the radiused corners of the valve element. The valve seal being partially disposed within a mounting groove formed in an edge surface about a substantial portion of the valve element. A plurality of flexure joints are formed in the seal member and in spaced relation from the curved portions. The plurality of flexure joints providing spring loading of the seal relative to the frame when the valve element is in a closed position.

### TECHNICAL FIELD

The present invention relates generally to the sealing of valves and, more specifically, to seals adapted for use in butterfly valves.

### BACKGROUND

Aircraft often fly at high altitudes, which are characterized by relatively low ambient pressures. As the altitude of an aircraft increases, the ambient pressure outside of the aircraft decreases and, unless otherwise controlled, excessive amounts of air could leak out of the aircraft cabin causing it to decompress to an undesirably low pressure. To provide passengers with a pleasant environment, it is desirable to maintain aircraft cabin pressure within a relatively comfortable range during flight. Aircraft cabin pressure is often referred to in terms of “cabin pressure altitude,” which refers to the normal atmospheric pressure existing at a certain altitude. Maintaining aircraft cabin pressure may be accomplished by controlling the rate at which air escapes from the aircraft's cabin utilizing one or more pressure outflow valves. Preferably, such outflow valves are relatively lightweight and compact, while at the same time being relatively durable and reliable.

One exemplary type of outflow valve that has been employed in aircraft is a butterfly valve. A butterfly valve is typically made up of a valve flowbody and a butterfly plate. The valve flowbody may be made of a rigid material, such as metal, and includes an inner surface defining a channel. The valve flowbody is configured to be disposed between the aircraft skin and the outside environment. The butterfly plate is made of a rigid material as well and is rotationally mounted to the valve flowbody. Conventionally, the butterfly plate is positioned in the channel such that a minimum clearance is formed with the inner surface of the valve flowbody. An actuator and a spring may be used to control the rotation of the butterfly plate.

Typically, the butterfly plate moves between closed, open, and partially open positions. When in the closed position, the butterfly plate substantially blocks the channel to prevent, or at least inhibit, air from flowing therethrough. When air flows through the valve flow body in a forward direction, the butterfly plate moves to the open or partially open position to allow air flow through the channel.

One specific type of butterfly valve design includes a dual rectangular butterfly type door, rotatably mounted within a housing to effect opening and closing of the valve. In addition, a resilient seal is mounted within the valve housing and surrounding the closure member. The seal provides a compliant, deformable interface between the valve closing member and the valve housing which affects a fluid tight seal when the closure member is rotated from the open to the closed position to compressively engage the seal.

Typically, in a dual rectangular butterfly type door design, a wiper type seal is positioned along the doorjamb to stop the flow of air. In some designs, the seal is created so that it is a continuous piece of pliable material that encompasses the radiused corners of the doors. Although the aforementioned valve configuration operates adequately, it may exhibit some drawbacks. For example, over the wiper seal many times experiences different deflections in the portion of the wiper seal that is positioned along the door jamb that is parallel to the axis of the hinges, as opposed to the jamb surfaces that are perpendicular to the axis of the hinges. The differing deflections increase leakage in the corners of the door, between the door plates and the jamb corners. To overcome this problem, multipiece seals that are separate and mated at the door corner have been found beneficial in improving the seal flexibility, but caused increased corner leakage.

Considering the foregoing, it should be appreciated that it would be desirable to provide a sealing means for an outflow valve wherein the seal is capable responding to differing deflections to substantially eliminate leakage from the valve. Other desirable features and characteristics of the present invention will become apparent from the subsequent detailed description of the invention and the appended claims, taken in conjunction with the accompanying drawings and this background of the invention.

### BRIEF SUMMARY

The present invention provides a seal adapted for use with a valve having a valve element rotatably mounted within a frame. In one embodiment and by way of example only, the seal comprises a flexible seal member including a plurality of curved portions and a plurality of flexure joints formed in the flexible seal member. The flexible seal member is partially disposed within a mounting groove formed in a perimeter edge surface about a substantial portion of the valve element. The plurality of flexure joints are formed in the flexible seal member and in spaced relation from the plurality of curved portions, the plurality of flexure joints providing spring loading of the flexible seal member relative to the frame when the valve element is in a closed position.

In another particular embodiment, and by way of example only, there is provided a valve assembly for controlling a flow of fluid, the valve assembly comprising a valve element and a seal. The valve element is disposed in a flow of fluid and includes at least one moveable plate rotatably mounted within a frame and configured to open and close to control the flow of a fluid therethrough. The at least one moveable plate is formed substantially rectangular in shape and includes a plurality of radiused corners. The seal includes a plurality of curved portions disposed about a substantial portion of a perimeter edge surface of the at least one moveable plate. The seal includes a plurality of flexure joints formed in spaced relation from the plurality of curved portions. The plurality of flexure joints provide spring loading of the seal relative to the frame when the valve element is in a closed position.

In yet another particular embodiment, and by way of example only, there is provided a valve assembly for controlling a flow of fluid. The valve assembly comprising a valve flowbody, a butterfly valve element, and a seal. The valve flowbody has a first port, a second port, and a flow passage there between. The butterfly valve element is disposed in the valve flowbody and includes a first moveable butterfly plate and a second moveable butterfly plate rotatably mounted within a frame and each is configured to open and close relative to the valve flowbody to control the flow of a fluid therethrough. Each of the first moveable butterfly plate and the second moveable butterfly plate are formed substantially rectangular in shape and include a plurality of radiused corners. The seal includes a plurality of curved portions disposed about a substantial portion of a perimeter edge surface of each of the first moveable butterfly plate and the second moveable butterfly plate. The seal includes a plurality of flexure joints formed in spaced relation from the plurality of curved portions. The plurality of flexure joints provide spring loading of the seal relative to the valve flowbody when the butterfly valve element is in a closed position.

Other independent features and advantages of the preferred valve seal will become apparent from the following detailed description, taken in conjunction with the accompanying drawings which illustrate, by way of example, the principles of the invention.

### BRIEF DESCRIPTION OF THE DRAWINGS

The preferred exemplary embodiment of the present invention will hereinafter be described in conjunction with the appended drawings, where like designations denote like elements, and:

FIG. 1 is a cutaway view of a valve assembly according to an embodiment;

FIG. 2 is an isometric view of a valve closure mechanism, in a closed state, employed by the valve assembly shown in FIG. 1;

FIG. 3 is an isometric view of a valve closure mechanism, in an open state, employed by the valve assembly shown in FIG. 1;

FIG. 4 is an isometric view of a portion of the valve closure mechanism employed by the outflow valve shown in FIGS. 2-3; and

FIG. 5 is an isometric view of a portion of a sealing means employed by the valve closure mechanism and outflow valve shown in FIGS. 2-3.

### DETAILED DESCRIPTION

The following detailed description of the inventive subject matter is merely exemplary in nature and is not intended to limit the inventive subject matter or the application and uses of the inventive subject matter. Furthermore, there is no intention to be bound by any theory presented in the preceding background of the inventive subject matter or the following detailed description of the inventive subject matter.

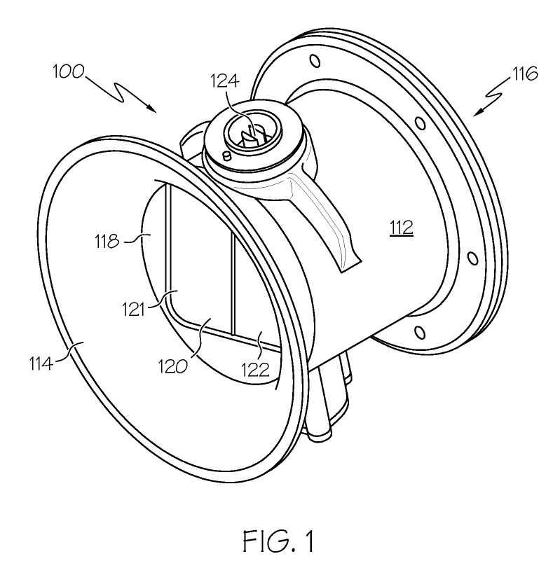

FIG. 1 is a simplified view of a valve assembly 110 according to an embodiment. The valve assembly 110 includes a valve flowbody 112 having a first flow port 114, a second flow port 116, and a flow passage 118 there between. It should be understood that the valve assembly 110 may be utilized in a variety of applications and is not limited to aircraft outflow valve applications as described herein. In addition, it should be understood that the valve assembly 110 may be configured to be disposed within the aircraft skin provide for a flow of fluid between an environment inside the aircraft and an environment outside the aircraft without the need for separately formed flow ports 114 and 116. The valve flowbody 112 is generally made of a metallic material. Examples of suitable materials include aluminum alloys, steel or titanium, to name a few. A valve element 120 is disposed in the valve flowbody 112 and may comprise one or more conventional valve components. In this preferred embodiment, the valve element 120 is a butterfly valve, and includes dual butterfly plates referred to herein as a first butterfly plate 121 and a second butterfly plate 122. In an alternate embodiment, a single butterfly plate may be used.

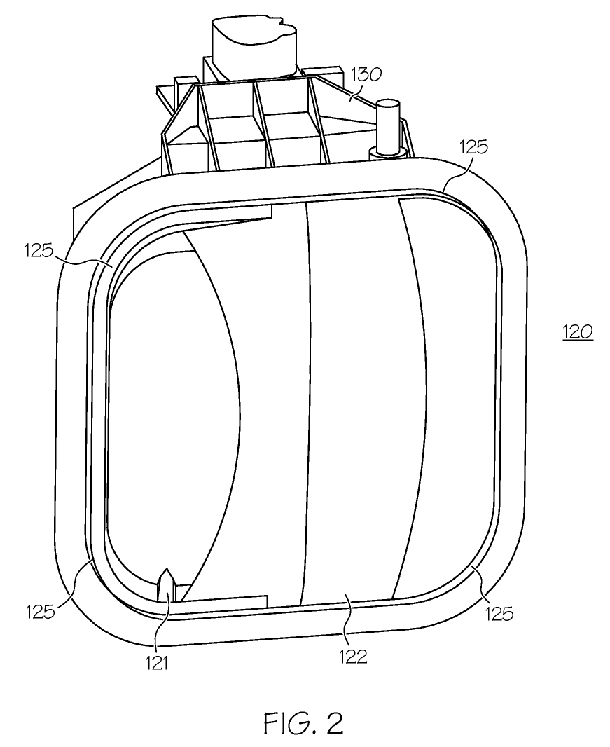

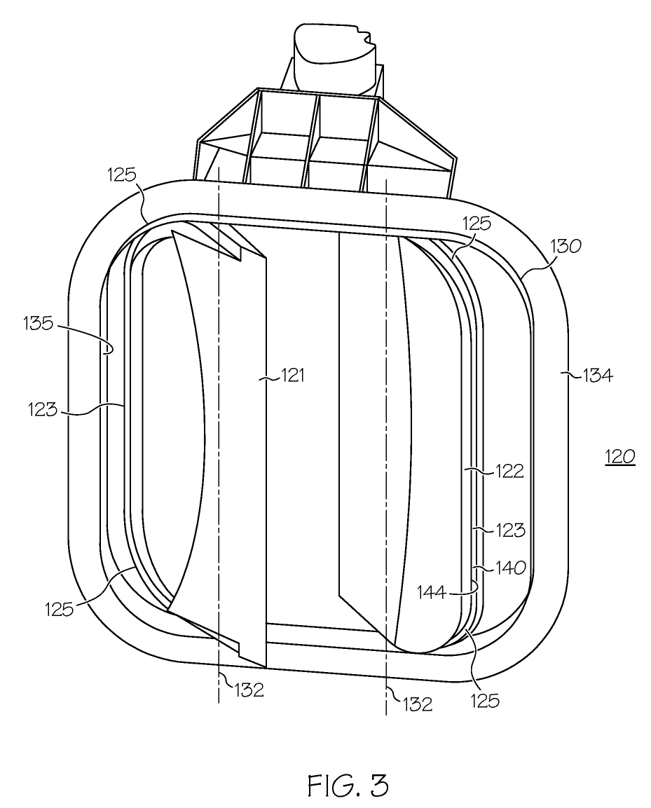

In an embodiment, the valve element 120 may be coupled to an actuator (not shown) that causes it to selectively open or close. The actuator may be any actuating mechanism, including, but not limited to, an electric actuator, a pneumatic actuator, a hydraulic actuator, or a manual actuator. A shaft 124 is mounted within the valve flowbody 112 and configured for rotational movement therein. The first and second butterfly plates 121 and 122 are coupled to shaft 124 by way of a plurality of fasteners, or the like. The actuator selectively rotates the shaft 124 in response to commands from a controller (not shown) to adjust the rotational position of the first and second butterfly plates 121 and 122 within the valve flowbody 112. For example, the actuator may rotate the shaft 124 to move valve element 120 between a substantially closed position (FIGS. 1 and 2), a substantially open position (FIG. 3), and various intermediate positions. In another embodiment, the first and second butterfly plates 121 and 122 may be biased toward the closed position by a spring. In particular, the spring may be coupled to the first and second butterfly plates 121 and 122 and may supply a force that urges first and second butterfly plates 121 and 122 toward the closed position. By adjusting the rotational positioning of the first and second butterfly plates 121 and 122 in this manner, the rate of pressurized airflow through the valve flowbody 112 may be controlled. When employed as a pressure outflow control valve, the valve assembly 110 may be mounted to such that the valve flowbody 112 is in fluid communication with a passenger cabin and an ambient air source. By adjusting the position of valve element 120 within the valve flowbody 112, the rate of airflow from the aircraft's cabin to the ambient air source may be controlled and, consequently, a desired cabin pressure altitude may be maintained.

Referring now to FIGS. 2 and 3, illustrated is a portion of the valve assembly 110, and in particular the first and second butterfly plates 121 and 122 in a closed position (FIG. 2) and in an open position (FIG. 3). In the illustrated embodiment, the first butterfly plate 121 and the second butterfly plate 122 are substantially rectangular in shape and include radiused corners 125. The first and second butterfly plates 121 and 122 are each rotationally mounted to the valve flowbody 112 via a hinge 131. The first and second butterfly plates 121 and 122 may be formed of a fiber-reinforced PEI, a fiber-reinforced PEEK, or aluminum, etc. As best illustrated in FIG. 3, the first and second butterfly plates 121 and 122 each rotate within a door frame 134 formed of a material such as steel about a door hinge axis 132, referred to herein as the y-axis. In one specific embodiment, the door frame 134 is mounted to the aircraft skin (not shown) and for a flow of fluid between an environment inside the aircraft and an environment outside the aircraft. In another specific embodiment, the door frame 134 is mounted within a flowbody as previously described. The valve assembly 110 further includes, a wiper type seal 140 formed of a material such as Teflon, a Dacron reinforced silicon material, or the like. The seal 140 is positioned substantially about a perimeter edge surface 123 of each of the first and second butterfly plates 121 and 122. More specifically, the seal 140 is disposed at least partially within a seal mounting groove (discussed presently) formed in the perimeter edge surface 123 of each of the first and second butterfly plates 121 and 122. In a preferred embodiment, the seal 140 is substantially “c” shaped and extends along substantially all perimeter edge surfaces 123 of each of the first and second butterfly plates 121 and 122.

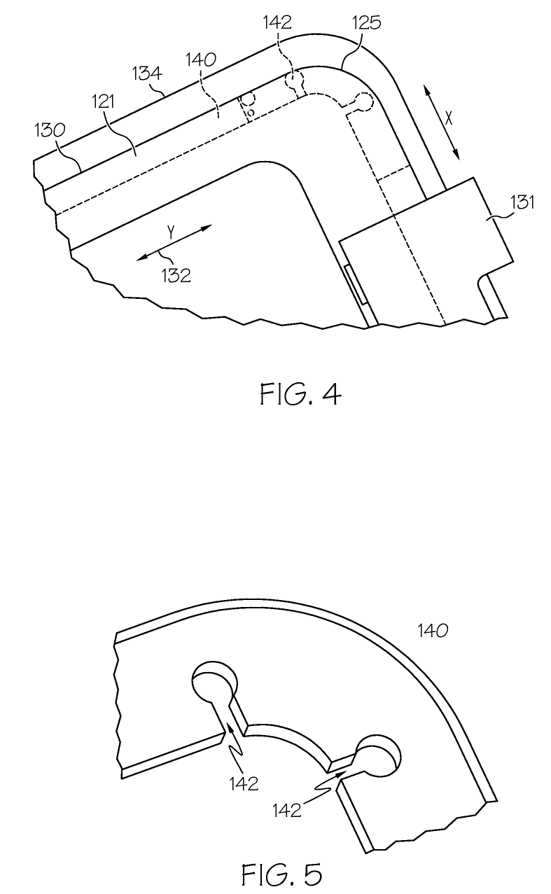

Referring now to FIGS. 4 and 5 in which the seal 140 is further described. FIG. 4 illustrates a portion of the valve assembly 110 with the seal 140, shown in hidden line, positioned relative to the first butterfly plate 121. The seal 140 is formed of a continuous, pliable material that encompasses the radiused corners 125 of each of the first and second butterfly plates 121 and 122. The seal 140 is configured to form a seal between the first and second butterfly plates 121 and 122 when in a closed position and the door frame 134 to prevent the flow of fluid in a forward flow direction and/or a reverse flow direction. As previously described, the seal 140 is partially disposed within a seal mounting groove 144 formed in each of the first and second butterfly plates 121 and 122. As best illustrated in FIG. 4 in hidden line, the seal 140 conforms to the radiused corners 125 on each of the first and second butterfly plates 121 and 122. The seal 140 provides a fluid seal when the first and second butterfly plates 121 and 122 are rotated to a closed position and contact a plurality of interior surfaces 135 of the door frame 134 (FIG. 2). When the first and second butterfly plates 121 and 122 are in a closed position, the seal 140 will experience different deflections along surfaces of the door frame 134 that are parallel to the axis of the hinges 131, and more particularly along the y-axis, as opposed to the surfaces of the door frame 134 that are perpendicular to the axis of the hinges 131, and more particularly along the x-axis. The differing deflections typically increase leakage in an area of the radiused corners 125 of the first butterfly plate 121 and the second butterfly plate 122. To provide for these differing deflections, the seal 140 includes a plurality of flexure joints 142 in cooperative alignment with the radiused corner 125 of the first butterfly plate 121 and the second butterfly plate 122 and a plurality of radiused corners 125 of the frame 134. The plurality of flexure joints 142 are formed as cut-out portions in the seal 140 that provide spring loading of the seal 140 relative to the interior surface 130 (FIG. 3) of the frame 134. The size, location, and shape of the plurality of flexure joints 142 may be configured to vary the amount of spring rate in the corners of the seal 140 and available seal deflection along the x-axis and y-axis. The plurality of flexure joints 142 are designed so that they are shrouded by the seal mounting groove 144, as best illustrated in FIG. 4, and do not create unwanted leakage.

A valve seal with integral flexure joints has now been provided. The valve seal is intended for use in a valve assembly for the control of fluid. The valve seal is capable of providing a seal between at least one butterfly plate and a door frame in which the butterfly plate rotates. The flexure joints formed in the valve seal provide for spring loading of the seal against the door frame, thus essentially eliminating any leakage between the seal and door frame. Additionally, the valve seal may be lightweight and relatively inexpensive to implement.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A seal adapted for use with a valve having a valve element rotatably mounted within a frame, the seal comprising:
a flexible seal member including a plurality of curved portions, the flexible seal member configured to be partially disposed within a mounting groove formed in a perimeter edge surface about a substantial portion of the valve element; and
a plurality of flexure joints formed in the flexible seal member and in spaced relation from the plurality of curved portions, the plurality of flexure joints providing spring loading of the flexible seal member relative to the frame when the valve element is in a closed position.

2. The seal as claimed in claim 1, wherein the plurality of flexure joints are a plurality of cut-out portions formed in the flexible seal member in spaced relation from one another.

3. The seal as claimed in claim 1, wherein the flexible seal member is formed of a silicone material.

4. The seal as claimed in claim 1, wherein the flexible seal member is formed of a polymer material.

5. The seal as claimed in claim 1, wherein the flexible seal member includes a perimeter mounting surface in contact with an interior surface of the mounting groove.

6. The seal as claimed in claim 1, wherein the flexible seal member is substantially c-shaped.

7. The seal as claimed in claim 1, wherein the valve element is a butterfly valve.

8. The seal as claimed in claim 7, wherein the butterfly valve includes at least one moveable butterfly plate.

9. The seal as claimed in claim 8, wherein the butterfly valve includes a first moveable butterfly plate and a second moveable butterfly plate.

10. A valve assembly for controlling a flow of fluid, the valve assembly comprising:
a valve element including at least one moveable plate rotatably mounted within a frame and configured to open and close relative to a flow of fluid to control the flow of a fluid therethrough, the at least one moveable plate formed substantially rectangular in shape and including a plurality of radiused corners; and
a seal including a plurality of curved portions disposed about a substantial portion of a perimeter edge surface of the at least one moveable plate, the seal including a plurality of flexure joints formed in spaced relation from the plurality of curved portions, the plurality of flexure joints providing spring loading of the seal relative to the frame when the valve element is in a closed position.

11. The valve assembly as claimed in claim 10, wherein the plurality of flexure joints are a plurality of cut-out portions formed in the seal in spaced relation from one another and correspond to the plurality of radiused corners of the at least one moveable valve plate.

12. The valve assembly as claimed in claim 10, wherein the seal is formed of a flexible silicone material.

13. The valve assembly as claimed in claim 10, wherein the seal is formed of a flexible polymer material.

14. The valve assembly as claimed in claim 10, wherein the at least one moveable plate includes a seal mounting groove formed about a substantial portion of an edge perimeter, the seal being at least partially disposed in the seal mounting groove.

15. The valve assembly as claimed in claim 14, wherein the seal includes a perimeter mounting surface in contact with an interior surface of the seal mounting groove, the plurality of flexure joints radially formed in the perimeter mounting surface of the seal and shrouded by the seal mounting groove.

16. The valve assembly as claimed in claim 10, wherein the valve element is a butterfly valve.

17. The valve assembly as claimed in claim 16, wherein the butterfly valve includes a first moveable butterfly plate and a second moveable butterfly plate.

18. The valve assembly as claimed in claim 10, wherein the valve element is disposed in an aircraft skin providing a flow of fluid between an environment inside the aircraft and an environment outside the aircraft.

19. A valve assembly for controlling a flow of fluid, the valve assembly comprising:
a valve flowbody having a first port, a second port, and a flow passage there between;
a butterfly valve element disposed in the valve flowbody, the butterfly valve element including a first moveable butterfly plate and a second moveable butterfly plate rotatably mounted within a frame and each configured to open and close relative to the valve flowbody to control the flow of a fluid therethrough, each of the first moveable butterfly plate and the second moveable butterfly plate formed substantially rectangular in shape and including a plurality of radiused corners; and
a seal including a plurality of curved portions disposed about a substantial portion of a perimeter edge surface of each of the first moveable butterfly plate and the second moveable butterfly plate, the seal including a plurality of flexure joints formed in spaced relation from the plurality of curved portions, the plurality of flexure joints providing spring loading of the seal relative to the valve flowbody when the butterfly valve element is in a closed position.

20. The valve assembly as claimed in claim 19, wherein each of the first moveable butterfly plate and the second moveable butterfly plate includes a seal mounting groove formed about a substantial portion of an edge perimeter, a portion of the seal being disposed in the seal mounting groove on each of the first moveable butterfly plate and the second moveable butterfly plate.
